(19) United States
(12) Patent Application Publication
(10) Pub. No.: US 2008/0094181 A1
(43) Pub. Date: Apr. 24, 2008

(54) Passive remote control

(75) Inventors: Yves Lenevez, Aubagne (FR); Philippe Lecire, Rognac (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Tagsys SAS, La Penne-Sur Huveaune (FR)

(21) Appl. No.: 11/893,586

(22) Filed: Aug. 16, 2007

Related U.S. Application Data
(60) Provisional application No. 60/854,411, filed on Oct. 24, 2006.

(51) Int. Cl. G08C 19/12; H04L 17/02

(52) U.S. Cl. 340/10.4; 341/176

(57) ABSTRACT

A device is disclosed for remotely transmitting a command to an apparatus. The device includes at least one RFID tag having stored therein a code corresponding to the command and is adapted to transmit the code in response to an interrogation signal. Typically the device may include a plurality of RFID tags, each tag having stored therein a code corresponding to a different command and being adapted to transmit the code in response to receiving the interrogation signal. Typically the at least one RFID tag is passive and relies on the interrogation signal for its operation.

### CROSS-REFERENCE TO RELATED APPLICATIONS

This application claims the benefit of the filing date of U.S. Provisional Patent Application No. 60/854,411 filed Oct. 24, 2006, the disclosure of which is hereby incorporated herein by reference.

### BACKGROUND OF THE INVENTION

The present invention relates to a remote control (RC) device. In particular the present invention relates to a passive RC device for remotely controlling apparatus such as a television receiver or garage door opener.

The passive RC device of the present invention may rely on the principle of radio frequency interrogation not unlike Radio Frequency Identification (RFID) tags. RFID tags are widely used to associate an object with data such as an identification code stored in the tag. An RFID tag may be read via the principle of electromagnetic (EM) communication wherein an interrogator containing a transmitter generates an EM signal that is transmitted via an antenna associated with the interrogator to an antenna associated with the tag. In a passive tag the antenna may receive a portion of the transmitted energy and through a rectifier generate DC power for operating a reply generation circuit. The reply generation circuit may encode the data stored in the tag into an EM reply signal that is radiated by the antenna. The radiated signal may be received by the interrogator antenna and the data may be decoded by the interrogator.

One advantage of a passive RC device is that it may not require an internal source of power such as a battery for its operation. Hence it may avoid the problem of the battery running flat. It may also avoid the extra space, weight and periodic replacements that are associated with battery operation. Because the proposed RC device may be passive, an interrogator may be required to determine whether there is a request for a command. The interrogator may be associated with an apparatus (e.g. television receiver) that is to be remotely controlled. Alternatively, the interrogator may stand alone or may be separate from the apparatus to be controlled. The interrogator may send out interrogation signals continuously or at least periodically to determine whether there is a request for a command. The interrogator may be set to a standby mode in which it ceases to send out interrogation signals after a period of time has elapsed and there has been no request for a command. The interrogator may be reset to an active mode via a motion sensor or the like or by other suitable means.

### SUMMARY OF THE INVENTION

According to one aspect of the present invention there is provided a device for remotely transmitting a command to an apparatus, said device including at least one RFID tag having stored therein a code corresponding to said command and adapted to transmit said code in response to an interrogation signal. The apparatus may include a television receiver, a heater or a hydrotherapy apparatus or the like.

The device may include a plurality of RFID tags, each tag having stored therein a code corresponding to a separate command and being adapted to transmit the code in response to receiving the interrogation signal. The or each RFID tag may be passive and may rely on the interrogation signal for its operation.

The device may include a plurality of switches, each switch being adapted to actuate a respective one of the plurality of RFID tags. Each switch may include a dome portion and a conductive portion. The conductive portion may be adapted to bridge two circuits when the switch is actuated. Each circuit may include a portion of a relay antenna. The device may include a master antenna and the relay antenna may provide an EM relay between a tag antenna associated with the RFID tag and the master antenna.

A remote control system according to the present invention may include an RC device as described above and apparatus for receiving a command transmitted by the device. An interrogator may be associated with the apparatus for generating the interrogation signal.

### BRIEF DESCRIPTION OF THE DRAWINGS

A preferred embodiment of the present invention will now be described with reference to the accompanying drawings wherein:

FIG. 1 is a top, perspective view schematically showing the principal stages in assembling a passive RC device according to one embodiment of the present invention;

FIG. 2 is a side, perspective, exploded view of the passive RC device of the present invention;

FIG. 3a is a side, elevational, partially cross-sectional view of a bubble switch in an unactuated position; and

FIG. 3b is a side, elevational, partially cross-sectional view of the bubble switch shown in FIG. 3a in an actuated position.

### DETAILED DESCRIPTION

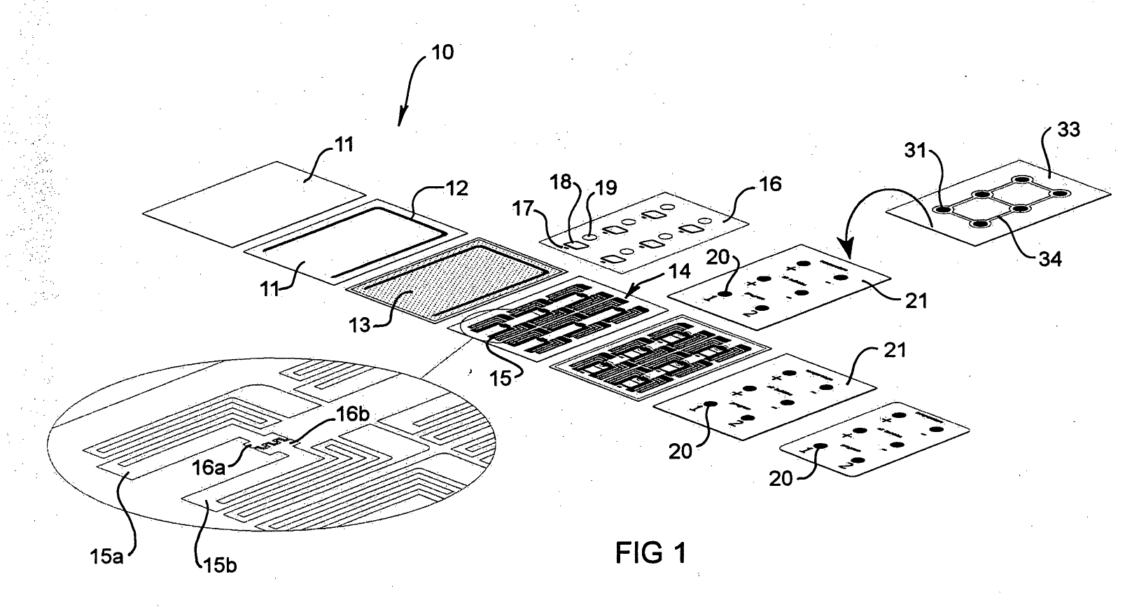

FIG. 1 shows seven stages in assembling a remote control (RC) device 10 according to the present invention. In a first stage a substrate 11 is provided. Substrate 11 may include an insulating base material such as plastics.

In a second stage a master secondary antenna 12 is laid down over the substrate 11 in any suitable manner and by any suitable means. In one form master antenna 12 may include conductive ink applied via a screen printing process. Master antenna 12 may be substantially U-shaped. In one form the resonant frequency of master antenna 12 may be substantially in the range 830-900 MHz.

In a third stage an insulating layer 13 is applied over master antenna 12 in any suitable manner and by any suitable means. In one form insulating layer 13 may include a film of varnish.

In a fourth stage a layer 14 including an array of slave antennas is applied over insulating layer 13 in any suitable manner and by any suitable means. A typical slave antenna 15 in layer 14 comprises two antenna parts 15a, 15b. Each antenna part 15a, 15b includes interdigitating finger portions 16a, 16b. The two antenna parts 15a, 15b may be connected together via a conductive bridge that contacts the interdigitating finger portions 16a, 16b.

When the two antenna parts 15a, 15b are connected together by a conductive bridge the slave antenna 15 may resonate at substantially the same frequency as master antenna 12 (substantially in the range 830-900 MHz) to facilitate EM coupling between the master and slave antennas. The resonant frequency of each antenna part 15a, 15b may be such that it may not separately perform the EM coupling. Slave antenna 15 is effectively switched on and performs the EM coupling when parts 15a, 15b are bridged and is effectively switched off at other times.

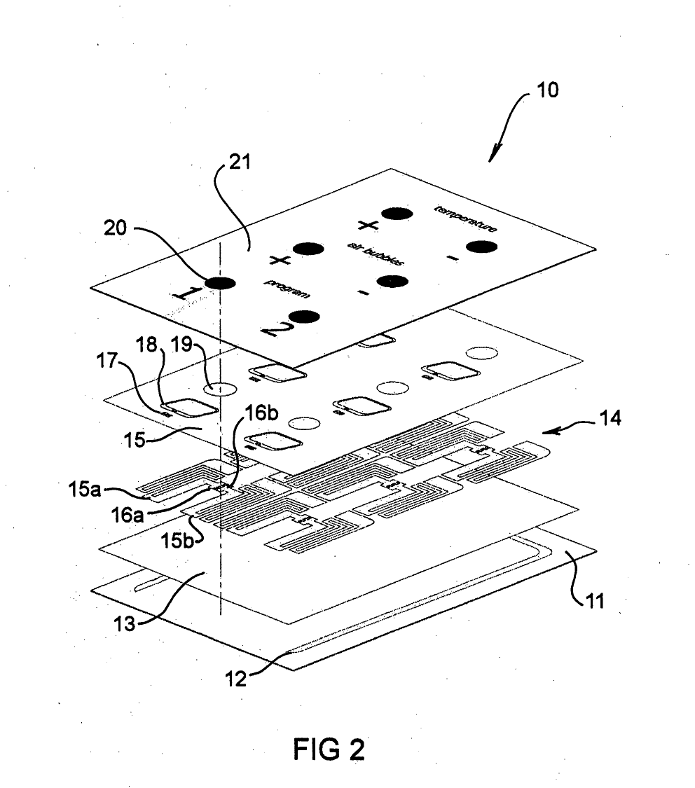

In a fifth stage a tag layer 16 is applied over the layer 14 of slave antennas. The tag layer 16 includes an adhesive film, an array of RFID tags and an associated array of secondary antennas. A typical RFID tag 17 comprises an AK tag module manufactured by Tagsys SAS. A typical secondary antenna 18 is positioned in proximity to the associated tag module 17 to enhance EM coupling with the tag antenna (not shown) on the tag module 17. The tag layer 16 includes a plurality of apertures to facilitate switching on of the slave antennas in layer 14. As shown in FIG. 2 a typical aperture 19 is aligned with finger portions 16a, 16b of slave antenna 15 and with bubble switch 20 in top layer 21.

In a sixth stage a top layer 21 is applied over the tag layer 16. Top layer 21 includes a plurality of bubble switches. Each bubble switch may be associated with a separate function in connection with an apparatus that is to be remotely controlled, such as up/down (±) adjustment of “temperature” in a heater monitor, up/down (±) adjustment of “program” in a television receiver and/or up/down (±) adjustment of “air bubbles” in a hydrotherapy apparatus.

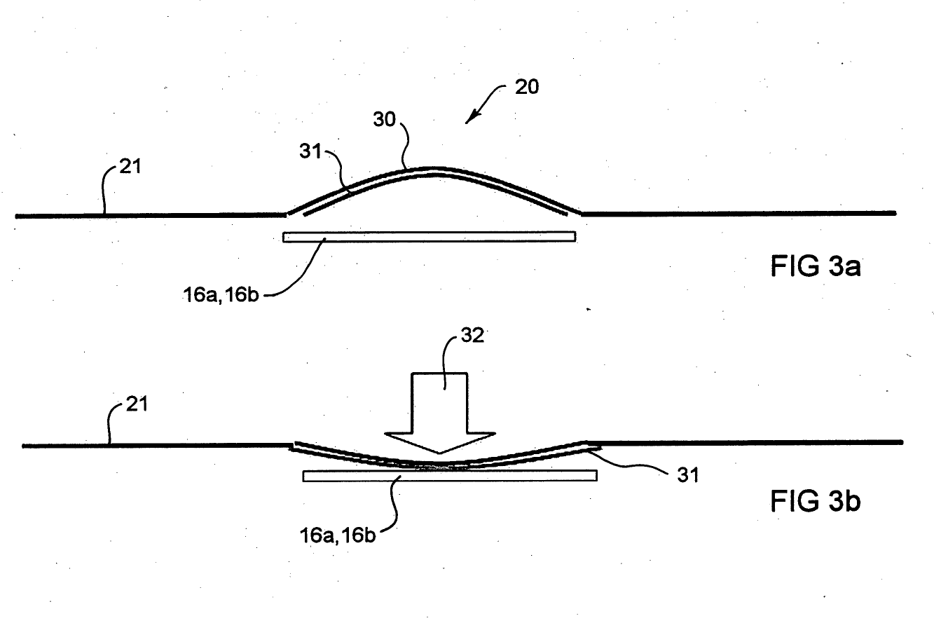

Referring to FIGS. 3a and 3b, a typical bubble switch 20 includes a dome portion 30 formed integrally with top layer 21. A conductive portion 31 is applied to an inner surface of dome portion 30. Conductive portion 31 may include a layer or coating of carbon or a carbon pill. Bubble switch 20 is flexuraly stable in the unactuated position shown in FIG. 3a. However, when switch 20 is actuated by pressure represented by arrow 32 applied to dome portion 30, the dome portion 30 inverts from a convex to a concave shape as shown in FIG. 3b. In the actuated position of switch 20, conductive portion 31 contacts and bridges finger portions 16a, 16b associated with antenna parts 15a, 15b.

When antenna parts 15a, 15b are bridged, slave antenna 15 is switched on and resonates at substantially the same frequency as master antenna 12. Slave antenna 15 then acts as an EM bridge or relay between secondary antenna 18 associated with RFID tag 17 and master antenna 12.

This allows data stored in RFID tag 17 to be readily communicated to an interrogator (not shown). The data that is stored in tag 17 may be a code that represents a function associated with switch 20, e.g. increment or increase a channel (“program”) by one unit. Each RFID tag on tag layer 16 may store a different code that represents a separate function to be performed by actuating the associated switch. For example the tag associated with the switch marked “temperature (−)” may store a code that represents the function decrement or decrease a temperature by one unit. Other tags may store further codes that represent corresponding functions that may be performed by the RC device.

A layer of adhesive 33 may be applied to the underside of top layer 21. The layer of adhesive 33 preferably has a sufficient thickness to maintain conductive portion 31 spaced away from bridging or contacting finger portions 16a, 16b. The layer of adhesive 33 may be applied substantially over the entire underside surface of top layer 21 excepting zones that are directly beneath the bubble switches and grooves 34 connecting the zones. Connecting grooves 34 are free of adhesive to allow air to circulate in the spaces or cavities beneath the bubble switches to prevent a build up of positive or negative air pressure beneath a bubble switch when it is actuated.

Finally in a seventh stage the outer perimeter of the assembled RC device 10 may be trimmed to a desired shape and/or size.

Finally, it is to be understood that various alterations, modifications and/or additions may be introduced into the constructions and arrangements of parts previously described without departing from the spirit or ambit of the invention.

Although the invention herein has been described with reference to particular: embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A device for remotely transmitting a command to an apparatus, said device including at least one RFID tag having stored therein a code corresponding to said command and adapted to transmit said code in response to an interrogation signal.

2. A device according to claim 1 including a plurality of RFID tags, each tag having stored therein a code corresponding to a separate command and being adapted to transmit said code in response to receiving said interrogation signal.

3. A device according to claim 1 wherein said at least one RFID tag is passive and relies on said interrogation signal for its operation.

4. A device according to claim 2 including a plurality of switches, each switch being adapted to actuate a respective one of said plurality of RFID tags.

5. A device according to claim 4 wherein each switch includes a dome portion and a conductive portion, said conductive portion being adapted to bridge two circuits when said switch is actuated.

6. A device according to claim 5 wherein each circuit includes a portion of a relay antenna.

7. A device according to claim 1 including a master antenna, wherein a relay antenna is adapted to provide an electromagnetic relay between a tag antenna associated with said RFID tag and said master antenna.

8. A remote control system including:
a device according to claim 1;
apparatus for receiving said command; and
an interrogator associated with said apparatus for generating said interrogation signal.

9. A remote control system according to claim 8 wherein said apparatus includes a television receiver, a heater or a hydrotherapy apparatus.
